(19) United States
(12) Patent Application Publication
(10) Pub. No.: US 2025/0347327 A1
(43) Pub. Date: Nov. 13, 2025

(54) SYSTEMS FOR A BRAKE SYSTEM

(71) Applicant: Dana Motion Systems Italia S.R.L., Reggio Emilia (IT)

(72) Inventors: Luca FONTANESI, Reggio Emilia (IT); Fabio NATALI, Modena (IT)

(21) Appl. No.: 18/662,348

(22) Filed: May 13, 2024

(51) Int. Cl. F16D 55/228; F16D 65/18; F16D 121/04; F16D 125/04

(52) U.S. Cl. CPC F16D 55/228; F16D 65/183; F16D 2121/04; F16D 2125/04

(57) ABSTRACT

Systems are provided for a brake assembly. In one example, a brake assembly includes a braking clamp physically coupled to a spindle via a plurality of fasteners, wherein the braking clamp includes a plurality of openings configured to receive a first plurality of actuators. The spindle includes a first plurality of openings shaped to receive the plurality of fasteners and a second plurality of openings shaped to receive a second plurality of actuators.

### TECHNICAL FIELD

The present description relates generally to a brake system.

### BACKGROUND AND SUMMARY

Vehicles rely on dedicated brakes to decrease a vehicle speed. Current braking system may include pistons and/or frictions discs that may be complex to manufacture. Thus, there is a demand for systems that are less complex than those available to decrease manufacturing costs and time.

The issues described above may be addressed by a brake assembly including a braking clamp physically coupled to a spindle via a plurality of fasteners, wherein the braking clamp comprises a plurality of openings configured to receive a first plurality of actuators; wherein the spindle comprises a first plurality of openings shaped to receive the plurality of fasteners and a second plurality of openings shaped to receive a second plurality of actuators.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a motor system.

FIG. 2 shows an example of a brake assembly.

FIG. 3A shows an interior of a motor housing.

FIG. 3B shows a port cover of the brake assembly.

FIG. 4A shows a braking disc and a braking clamp positioned about a spindle of the brake assembly.

FIG. 4B shows an additional view of the braking disc.

FIGS. 5A and 5B show views of the braking clamp.

FIG. 6 shows a transparent view of the braking clamp coupled to the spindle.

FIG. 7 shows an exploded view of the brake assembly.

FIG. 8A shows a detailed view of the spindle.

FIG. 8B shows a detailed view of a hydraulic passage interfacing with the spindle.

FIG. 9 shows an example of a hydraulic system of the motor.

### DETAILED DESCRIPTION

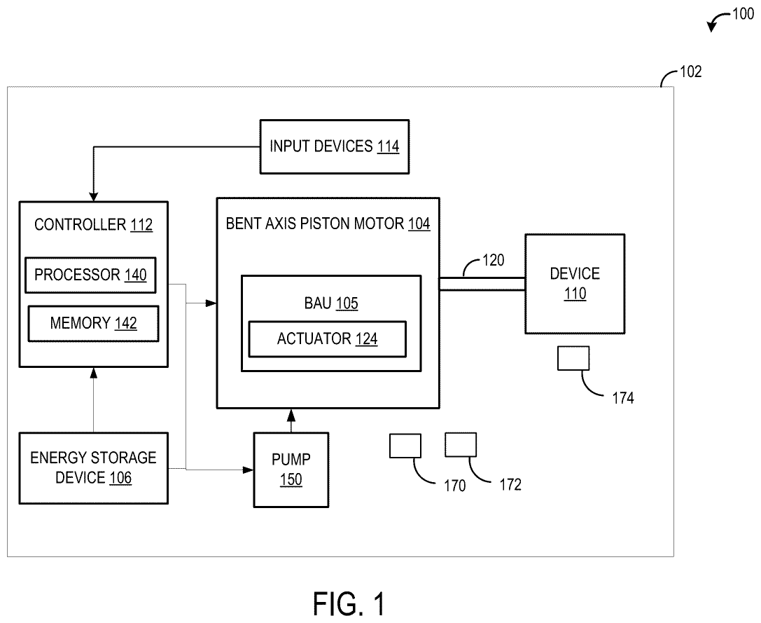

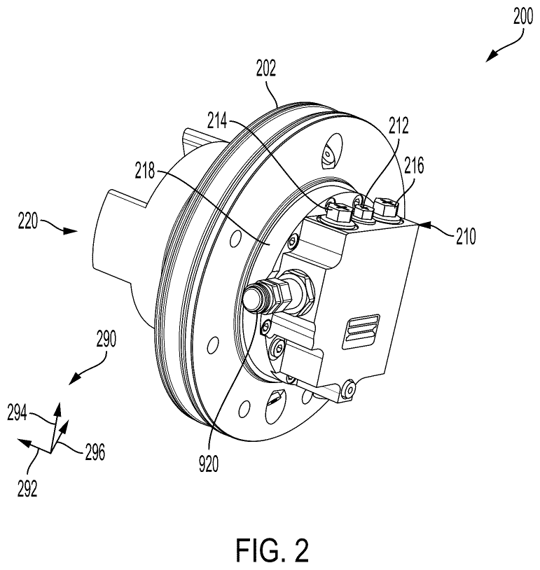

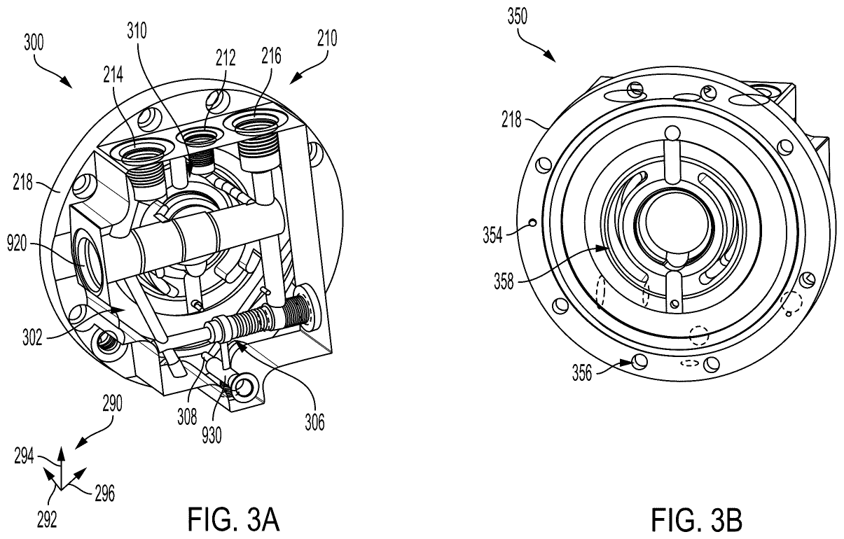

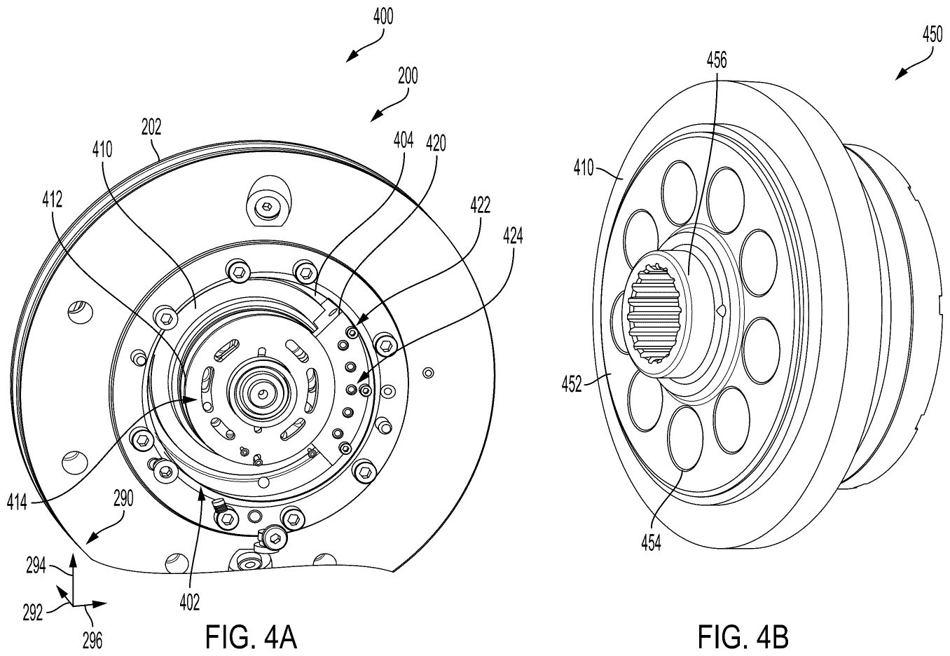

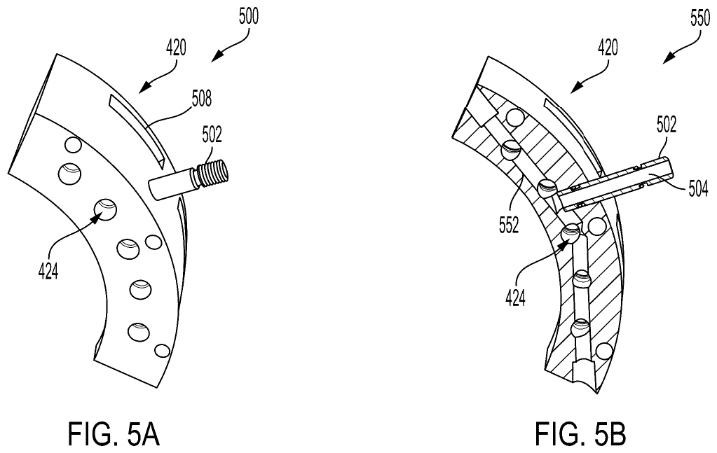

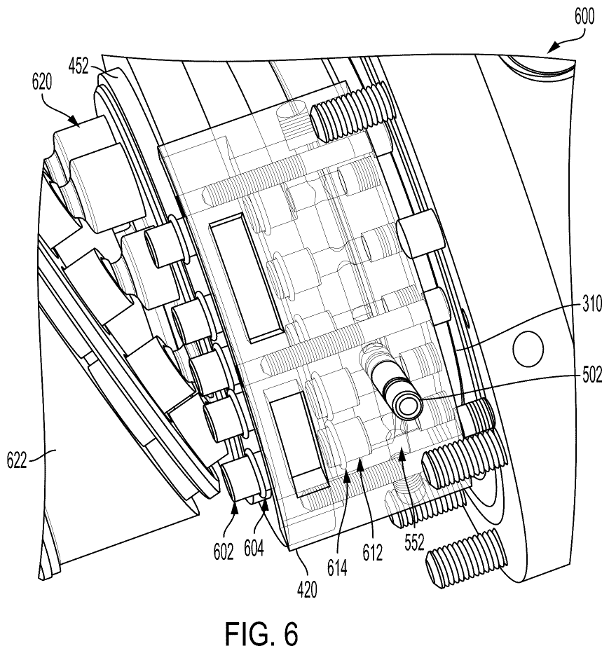

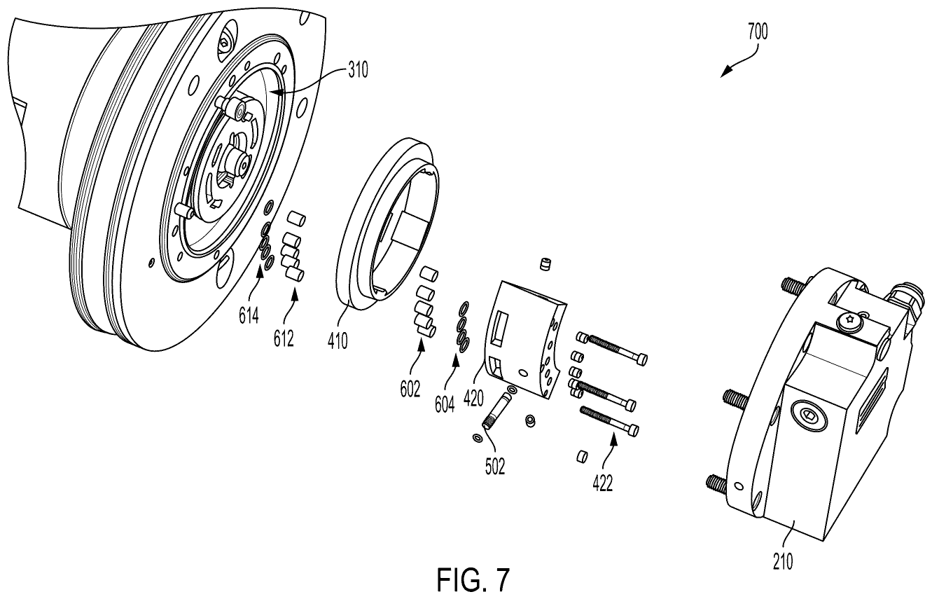

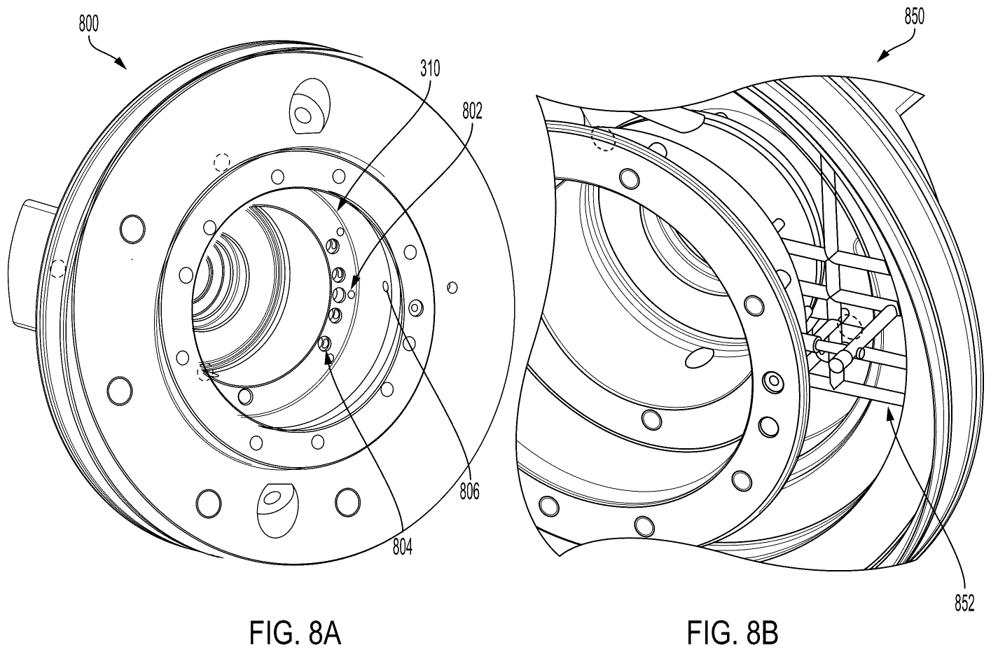

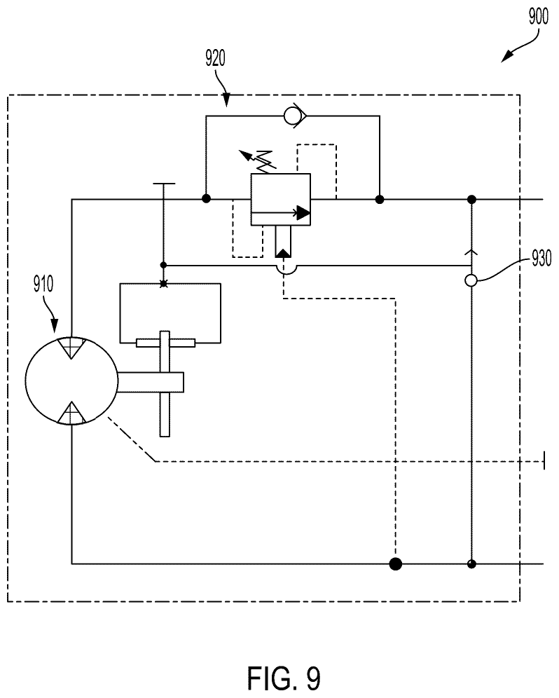

The following description relates to systems for a brake assembly. The brake assembly may be included in an axle of a vehicle. FIG. 1 shows an example of a motor system. FIG. 2 shows an example of a brake assembly. FIG. 3A shows an interior of a motor housing. FIG. 3B shows a port cover of the brake assembly. FIG. 4A shows a braking disc and a braking clamp positioned about a spindle of the brake assembly. FIG. 4B shows an additional view of the braking disc. FIGS. 5A and 5B show views of the braking clamp. FIG. 6 shows a transparent view of the braking clamp coupled to the spindle. FIG. 7 shows an exploded view of the brake assembly. FIG. 8 shows a detailed view of the spindle. FIG. 9 shows an example of a hydraulic system of the motor.

Referring now to FIG. 1, a schematic depiction of a motor system 100 of a vehicle 102 is shown, including a hydraulic piston motor 104 coupled to a controller 112, and to device 110 of the vehicle via a shaft 120. It should be appreciated that while FIG. 1 refers to an embodiment within a vehicle, in other embodiments, the motor system 100 may not be included in a vehicle, and may be included in a different machine that generates torque for a purpose other than propulsion. In one example, the device 110 may be a brake system, wheels, or other device operated via the motor system 100.

The piston motor 104 includes a BAU 105. Pump 150 rotates an actuator 124, such as a cylinder block (specifically, a BAU rotary group), of BAU 105 via pressurized fluids. As the cylinder block rotates, an amount of torque is generated on the drive shaft 120 by pressurized hydraulic fluid pumped into the BAU 105 by the pump 150. The pump 150 may be part of a hydraulic circuit comprising a regulator and/or valves for controlling the flow of hydraulic fluid. The pump 150 may be powered via energy from an energy storage device 106. To increase or decrease the amount of torque, an inclination angle of the BAU rotary group with respect to the drive shaft 120 may be adjusted. By adjusting the inclination angle, a displacement of the BAU rotary group may be increased, causing the amount of torque to increase, or the displacement of the BAU rotary group may be decreased, causing the amount of torque to decrease.

Controller 112 may include a processor 140 and a memory 142. Memory 142 may hold instructions stored therein that when executed by the processor cause the controller 112 to perform various methods, control strategies, diagnostic techniques, etc. For example, the various methods may include adjusting the inclination angle of the cylinder block with respect to drive shaft 120, to vary the amount of torque applied to drive shaft 120 (e.g., in response to an operator input). Processor 140 may include a microprocessor unit and/or other types of circuits. Memory 142 may include known data storage mediums such as random access memory, read only memory, keep alive memory, combinations thereof, etc. Memory 142 may include non-transitory memory.

Controller 112 may receive vehicle data and various signals from sensors positioned in different locations in the piston motor 104 and/or vehicle 102. The sensors may include an oil temperature sensor 170, an engine velocity sensor 172, one or more wheel velocity sensors 174, and/or other sensors of a piston motor 104 (e.g., torque sensors, pressure sensors, valve plate angle sensor, etc.). Controller 112 may send control signals to one or more actuators of a piston motor 104, in response to operator input and/or based on the received signals from the sensors. For example, controller 112 may adjust a speed and/or torque generated on drive shaft 120 in response to operator input and/or based on the received signals from the sensors.

The motor system 100 may include one or more input devices 114. For example, input devices 114 may include a pedal of the vehicle (e.g., an accelerator pedal), a control stick (e.g., a forward-neutral-reverse (FNR) lever), one or more buttons, or similar types of control, or combinations thereof. In one example, a FNR lever is used to operate the vehicle in a forward direction or a reverse direction, and an accelerator pedal is used to increase or decrease a speed of the vehicle. The input devices 114, responsive to driver input, may generate a torque adjustment request and a desired drive direction (a forward or reverse drive direction). For instance, when a speed adjustment requested is received by the controller, an output speed of the piston motor 104 may be correspondingly increased.

A hydraulic diagram of the motor system 100 is shown in FIG. 9. Therein, a hydraulic system 900 includes a motor 910, an over-center valve 920, and a check valve 930. The over-center valve 920 may be configured to control fluid flow pressurized by the motor 910 from flowing out of a motor housing.

Turning now to FIG. 2, it shows an example of a brake assembly 200 including a spindle 202. The spindle 202 may be arranged between a motor housing 210 and an axle coupling 220. The motor housing 210 may include ports including a drain 212, an inlet 214, and an outlet 216. The motor housing 210 may further include the over-center valve 920 and a port cover 218. As such, components previously introduced may be similarly numbered in this and subsequent figures.

An axis system 290 is shown including three axes, namely an axial axis 292, a lateral axis 294, and a transverse axis 296. The axial axis may be normal to a direction of vehicle travel. The lateral axis may be normal to the axial axis. The transverse axis may be parallel to a forward and a reverse direction of vehicle travel.

FIG. 3A shows a cross-sectional view 300 illustrating an interior 302 of the motor housing 210 and an interior side of the port cover 218. The check valve 930 is fluidly coupled to a brake line 308. A metering device 306 may be configured to control hydraulic fluid flow.

FIG. 3B shows a view 350 of an exterior side of the port cover 218. The brake line 308 extends from a first radial position to a second radial position corresponding to an opening 354. The opening 354 may be smaller than a plurality of through-holes 356 arranged proximally to a circumference of the port cover 218.

The port cover 218 may further include a pair of elongated openings 358 arranged proximally to a center of the port cover 218. In one example, the pair of elongated openings 358 may include an arc shape. The elongated openings 358 may be shaped to receive a braking disc, such as braking disc 410 of FIG. 4A.

Turning now to FIG. 4A, it shows an embodiment 400 of the brake assembly 200 without the motor housing 210 of FIG. 2. Therein, a braking disc 410 may be arranged within a central interior volume 402 of the spindle 202. An adapter plate 412 may be arranged between the braking disc 410 and the motor housing 210. The adapter plate 412 may include a plurality of slots 414. The plurality of slots 414 may be configured to distribute pressure to cylinders of a block of the motor.

A braking clamp 420 may be coupled to a barrel 404 of the spindle 202. The braking clamp 420 may be fixedly coupled to the spindle 202 via a plurality of fasteners 422. The braking clamp 420 may include a plurality of openings 424 through which a plurality of actuators may be inserted. The plurality of actuators is described in greater detail below.

In this way, a braking system may be arranged proximally to the spindle 202. The braking system may include the braking disc 410 physically coupled to a barrel, fit with interference, or with an interlocking mechanism, such as teeth and millings. The braking disc may be manufactured with high performance friction material.

Turning now to FIG. 4B, it shows a view 450 of a block 452 including a plurality of chambers 454 in which a plurality of pistons, such as pistons 620 of FIG. 6, may oscillate. The adapter plate 412 may be positioned onto the hub 456 positioned at a center of the block 452.

Turning now to FIG. 5A, it shows a view 500 of the braking clamp 420. The braking clamp 420 may include a pipe 502 coupled to a piloting line, such as the brake line 308 via opening 354 of FIGS. 3A and 3B. The pipe 502 may be threaded at its extreme ends. A plurality of cutouts 508 may be arranged proximally to the pipe 502. O-rings or other sealing elements may be arranged in the plurality of cutouts to block fluid from entering the housing.

FIG. 5B shows a cross-sectional view 550 of the braking clamp 420 and the pipe 502. As illustrated, the pipe 502 includes an internal passage 504 coupled to a clamp passage 552. The clamp passage 552 may extend toward each of the plurality of actuators that extends through the plurality of openings 424. The braking clamp 420 may be a single piece brake system. Brake fluid may be distributed via the braking clamp 420 to a plurality of actuators (e.g., a plurality of flow devices).

Turning now to FIG. 6, it shows a transparent view 600 of the braking clamp 420 coupled to the spindle 310. A first plurality of actuators 602 may extend through the plurality of openings 424. A second plurality of actuators 612 may extend through a plurality of spindle openings, such as the plurality of spindle openings 802 of FIG. 8. The first plurality of actuators 602 may include a first plurality of O-rings 604 and the second plurality of actuators 612 may include a second plurality of O-rings 614 to block leakage from the clamp passage 552.

In one example, the braking clamp 420 may be physically coupled to spindle 202 of FIG. 2. The braking clamp 420 may provide the pressurized hydraulic fluid to the block 452. A plurality of pistons 620 may be actuated by a swash plate 622 of a motor and hydraulic fluid provided by the braking clamp 420, such as the motor 100 of FIG. 1. The plurality of pistons 620 may tighten the brake disc to execute a braking action.

Turning now to FIG. 7, it shows an exploded view 700 of the brake system arranged in the spindle 310. Therein, the second plurality of O-rings 614 are inserted prior to the second plurality of actuators 612. The brake disc 410 may be arranged radially interior to the second plurality of actuators 612. The second plurality of actuators 612 may be coupled to the spindle 310 and the first plurality of actuators 602 may be coupled to the braking clamp 420. The braking clamp 420 is physically coupled to the spindle 310 via the plurality of fasteners 422.

When the motor is operating, hydraulic fluid may not be provided to the brake disc 410. When the motor is not operating and the pistons 620 are stationary, hydraulic fluid may be provided to the brake disc 410. The first and second pluralities of actuators may apply a force onto the brake disc 410 via hydraulic fluid flowing therethrough.

Turning now to FIG. 8A, it shows an embodiment 800 of the spindle 310 including a first plurality of through holes 802 and a second plurality of through holes 804. The first plurality of through holes 802 may be threaded and configured to receive the plurality of fasteners 422. The second plurality of through holes 804 may be configured to receive the second plurality of actuators 612. FIG. 8B shows an embodiment 850 illustrating a brake pressure fluid routing. In one example, the hydraulic circuit 852 may fluidly couple to the pipe 502 of the braking clamp 420 via an opening 806 of FIG. 8A. As illustrated in FIGS. 8A and 8B, the spindle 310 may be machined to include only the openings (e.g., holes) for the second plurality of actuators 612 and for receiving brake pressure fluid. The spindle 310 is free of machined seats shaped to receive braking discs and/or a brake piston. In one example, the spindle 310 does not include any machined seats and only includes holes for the actuators, the fasteners, and brake fluid.

In one example, the actuators are cylindrical. The second plurality of actuators 612 are inserted in the spindle 202 and the first plurality of actuators 602 are inserted into the braking clamp 420. When the pressure is not present (e.g., hydraulic fluid flow less than a threshold), the actuators do not touch the brake disc 410 and therefore the whole rotating assembly is free to move. When pressure is present, the pressure behind the actuators is all pushed against the brake disc 410 in such a way as to have a braking torque such as to block the rotation of the brake disc 410. Once the pressure is removed, braking torque is no longer present and the braking disc 410 returns to the cylinder block 452.

The disclosure also provides support for a brake assembly, comprising: a braking clamp physically coupled to a spindle via a plurality of fasteners, wherein the braking clamp comprises a plurality of openings configured to receive a first plurality of actuators and a second plurality of actuators, wherein the spindle comprises a first plurality of openings shaped to receive the plurality of fasteners. In a first example of the system, the spindle comprises cutouts for only the plurality of fasteners and brake fluid lines. In a second example of the system, optionally including the first example, the first plurality of actuators is configured to direct hydraulic fluid to a brake disk proximal to the braking clamp. In a third example of the system, optionally including one or both of the first and second examples, the second plurality of actuators is configured to direct hydraulic fluid to a brake disk proximal to the braking clamp. In a fourth example of the system, optionally including one or more or each of the first through third examples, the first plurality of actuators is spaced away from the second plurality of actuators. In a fifth example of the system, optionally including one or more or each of the first through fourth examples, the braking clamp comprises a pipe fluidly coupled to a clamp passage. In a sixth example of the system, optionally including one or more or each of the first through fifth examples, the clamp passage is fluidly coupled to each of the first plurality of actuators and the second plurality of actuators.

The disclosure also provides support for a system, comprising: a motor coupled to a hydraulic circuit, and a brake system comprising a braking clamp comprising a plurality of actuators inserted therein, the plurality of actuators configured to direct hydraulic fluid to a brake disk. In a first example of the system, the plurality of actuators comprises a first plurality of actuators and a second plurality of actuators, wherein actuators of the plurality of actuators are identical in size and shape. In a second example of the system, optionally including the first example, the braking clamp comprises a clamp passage fluidly coupled to a plurality of openings arranged in the braking clamp, wherein the plurality of actuators is inserted into the plurality of openings. In a third example of the system, optionally including one or both of the first and second examples, the plurality of actuators is fluidly coupled to the clamp passage. In a fourth example of the system, optionally including one or more or each of the first through third examples, the clamp passage is fluidly coupled to a pipe that extends from the clamp passage to an area outside of the braking clamp. In a fifth example of the system, optionally including one or more or each of the first through fourth examples, the brake system comprises only one braking clamp. In a sixth example of the system, optionally including one or more or each of the first through fifth examples, the braking clamp is a single piece. In a seventh example of the system, optionally including one or more or each of the first through sixth examples, the braking clamp is coupled to a spindle via a plurality of fasteners.

The disclosure also provides support for a system, comprising: a motor coupled to a hydraulic circuit, and a braking clamp physically coupled to a spindle via a plurality of fasteners, wherein the braking clamp comprises a plurality of openings configured to receive a first plurality of actuators, wherein the spindle comprises a first plurality of openings shaped to receive the plurality of fasteners and a second plurality of openings shaped to receive a second plurality of actuators. In a first example of the system, the first plurality of actuators is inserted into the braking clamp and the second plurality of actuators is inserted into the spindle. In a second example of the system, optionally including the first example, the brake rotor comprises a plurality of slots configured to distribute pressure to a plurality of cylinders of a block of the motor. In a third example of the system, optionally including one or both of the first and second examples, the braking clamp comprises a plurality of cutouts along an outer edge. In a fourth example of the system, optionally including one or more or each of the first through third examples, the braking clamp comprises an arc shape.

FIGS. 2-8B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-8 are shown approximately to scale. Embodiments including other dimensions may be used if desired.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A brake assembly, comprising:
a braking clamp physically coupled to a spindle via a plurality of fasteners, wherein the braking clamp comprises a plurality of openings configured to receive a first plurality of actuators and a second plurality of actuators; wherein
the spindle comprises a first plurality of openings shaped to receive the plurality of fasteners.

2. The brake assembly of claim 1, wherein the spindle comprises cutouts for only the plurality of fasteners and brake fluid lines.

3. The brake assembly of claim 1, wherein the first plurality of actuators is configured to direct hydraulic fluid to a brake disc proximal to the braking clamp.

4. The brake assembly of claim 1, wherein the second plurality of actuators is configured to direct hydraulic fluid to a brake disc proximal to the braking clamp.

5. The brake assembly of claim 1, wherein the first plurality of actuators is spaced away from the second plurality of actuators.

6. The brake assembly of claim 1, wherein the braking clamp comprises a pipe fluidly coupled to a clamp passage.

7. The brake assembly of claim 6, wherein the clamp passage is fluidly coupled to each of the first plurality of actuators and the second plurality of actuators.

8. A system, comprising:
a motor coupled to a hydraulic circuit; and
a brake system comprising a braking clamp comprising a plurality of actuators inserted therein, the plurality of actuators configured to direct hydraulic fluid to a brake disc.

9. The system of claim 8, wherein the plurality of actuators comprises a first plurality of actuators and a second plurality of actuators, wherein actuators of the plurality of actuators are identical in size and shape.

10. The system of claim 8, wherein the braking clamp comprises a clamp passage fluidly coupled to a plurality of openings arranged in the braking clamp, wherein the plurality of actuators is inserted into the plurality of openings.

11. The system of claim 10, wherein the plurality of actuators is fluidly coupled to the clamp passage.

12. The system of claim 10, wherein the clamp passage is fluidly coupled to a pipe that extends from the clamp passage to an area outside of the braking clamp.

13. The system of claim 8, wherein the brake system comprises only one braking clamp.

14. The system of claim 8, wherein the braking clamp is a single piece.

15. The system of claim 8, wherein the braking clamp is coupled to a spindle via a plurality of fasteners.

16. A system, comprising:
a motor coupled to a hydraulic circuit; and
a braking clamp physically coupled to a spindle via a plurality of fasteners, wherein the braking clamp comprises a plurality of openings configured to receive a first plurality of actuators; wherein
the spindle comprises a first plurality of openings shaped to receive the plurality of fasteners and a second plurality of openings shaped to receive a second plurality of actuators.

17. The system of claim 16, wherein the first plurality of actuators is inserted into the braking clamp and the second plurality of actuators is inserted into the spindle.

18. The system of claim 17, wherein a brake disc comprises a plurality of slots configured to distribute pressure to a plurality of cylinders of a block of the motor.

19. The system of claim 16, wherein the braking clamp comprises a plurality of cutouts along an outer edge.

20. The system of claim 16, wherein the braking clamp comprises an arc shape.
